(19) United States
(12) Patent Application Publication
(10) Pub. No.: US 2024/0181442 A1
(43) Pub. Date: Jun. 6, 2024

(54) Parametric Multi Component Dispenser

(71) Applicant: Maksim Nilov, Princeton, NJ (US)

(72) Inventor: Maksim Nilov, Princeton, NJ (US)

(21) Appl. No.: 18/209,049

(22) Filed: Jun. 13, 2023

Related U.S. Application Data
(60) Provisional application No. 63/400,188, filed on Aug. 23, 2022.

(51) Int. Cl. B01L 3/02; B01L 9/00

(52) U.S. Cl. CPC B01L 3/0293; B01L 9/00; B01L 2200/025; B01L 2200/026; B01L 2200/04; B01L 2200/0689; B01L 2400/0605

(57) ABSTRACT

A fluid dispensing device which enables one or two fluid mixture components to be selectively or simultaneously dispensed via manually operable selection and actuation means. A dispenser which incorporates a body, one or more fluid storage and delivery channels, a selection and actuation means operable to cause the release of a quantity of a one or more stored fluid, and a base or work station adapted for upright storage, refilling, and use of the said dispenser, are disclosed herein. One or more said fluid storage and delivery channels may be engaged by said control means in order to eject one or more fluids. The said dispenser includes a ratio-metric scale system which permits ratio based selection of two fluids for ejection in a first mode of operation, and permits selection of a particular volume of a fluid for ejection in a second mode of operation.

### CROSS-REFERENCE TO RELATED APPLICATION(S)

This application claims the benefit of U.S. Provisional Patent Application No. 63/400,188, filed on Aug. 23, 2022, which is incorporated by reference herein in its entirety.

### BACKGROUND OF INVENTION

### a. Field of Invention

The invention relates generally to multi chambered dispensing devices capable of metering or proportioning the dispensed fluids. Particularly, the invention relates to a compact fluid dispenser capable of ejecting variable fluid volumes in response to operation of said dispenser, which is preferably accomplished via a manually applied force on a control surface of an articulated selection and actuation system.

### b. Background of Invention

Visual artists, makeup users, and laboratory technicians may want to formulate mixtures quickly and accurately, in order to be more productive in routine tasks which require precise fluid dispensing. Through iterative use of the current dispenser, a mixture with any number of components, in any proportion to each other, may be produced.

Those who use fluid pigment mixtures such as paints and makeup are often faced with a set of fundamental challenges. These problems include metering of fluid materials, then mixing the same in order to achieve a particular visual appearance, ie. a particular hue, and producing a sufficient amount of such a mixture in order to coat a particular surface. The present invention is oriented towards facilitating iterative and parametric development of mixtures and solutions. The said invention is also capable of repeatably producing a previously developed mixture, as well as assisting in efficiently carrying out studies such as assays and titrations.

Experimenters and laboratory technicians may want an instrument which allows one to avoid expensive, fragile or bulky equipment in order to perform routine analytical or quality control testing. The present invention is aimed to streamline titrations where two or more fluids are involved in a given reaction. Titrations can be performed in a more flexible manner because proportions of analyte to titrant may be altered and reversed dynamically and iteratively, in contrast to a conventional linear approach of adding a titrant to an analyte.

The present device may also act as an assay generator, in that it may enable the user to create a sequence of mixtures having pre-determined ratios, enabling one to alter the components present, as well as their mutual ratios or volumes, iteratively and quickly.

Disclosed herein is a volumetric dispenser which can repeatably produce specific fluid component formulations in response to actuation of a selection and actuation disc or key like disc section, preferably by localized manual depression of the said disc or disc section.

### c. Description of Related Art

Fluid dispensers which form a mixture from individual fluid components are known, and are taught by Max Lieber's U.S. Pat. No. 6,527,201, by Anton Brugger's U.S. Pat. No. 6,464,107, and by Girair Hagop Alticosalian's U.S. Pat. No. 4,006,841.

Lieber's airbrush color changer can deliver two colors simultaneously. It requires a source of compressed air to operate and is designed to work with substantially fluid paints. It is limited to the delivery of two mixture components for real-time application and is designed for use exclusively with airbrushes.

Brugger's U.S. Pat. No. 6,464,107 contemplates a swash plate which interacts with fluid stores. Each one of the taught fluid stores is equipped with a pump means. According to the author, in one proposed embodiment, a ratio of two fluids may be selected for dispensing by pivoting a housing head. Brugger's device presents relatively long fluid paths, introducing priming delays and likely inaccuracies in metering fluids, as well as opportunities for cross-contamination. The shared manifold and nozzle, as well as an inherent need to prime the taught pump means, may reduce metering repeatability and responsiveness of the disclosed device.

Alticosalian's dispenser allows one to select a ratio between two fluids via a rotary knob. Dispensing of stored fluids is actuated by manually pressing said knob. This device is not a volumetric dispenser and relies on pressurized containers to store fluids. Metering fluids from pressurized containers may be a quasi stochastic process, relying on varying the size of a metering orifice, or by varying the time alloted for ejection.

Notwithstanding the prior art, the present invention is neither taught nor rendered obvious thereby.

### d. Objects and Advantages

An objective of the current invention is a parameter driven, volumetric hand held dispenser that can meter out fluids simultaneously or sequentially, and may act as a color synthesizer for art, design, and related fields, a synthesizer for perfumery, cosmetics and related fields, or as a laboratory fluid doser for performing assays, titration, and other kinds of analyses in the field of chemistry.

The current invention has been designed to simplify and accelerate access to multiple fluid materials, as it allows a user to substantially bypass repetitive and tedious actions such as opening and closing of bottles when working with gels and fluids. The said materials or fluids may reside in reservoir like cartridges (3101) which may be swapped into, or out of, the current device's cartridge fitting or seating means (3102). The currently taught dispenser (100) generally acts as a multi material reservoir pipette with rapid ratio selection.

Another objective of the current invention is to leverage an artist's knowledge of a conceptual color wheel. To that end, dispenser (100) may include fluid stores (c), (m), (y) which may respectively contain the mixing primaries Cyan, Magenta and Yellow, disposed around a common axis in the notional positions of subtractive primary colors on a color wheel's circumference. A user may select a ratio of a first color component to a second color component for dispensing. This said ratio based dispensing is possible between any of the components in the currently taught triadic circumferential arrangement. The user is free to compose secondary colors by accessing a continuum of mixing ratios between the primary colors thus arranged for dispensing.

The current invention enables an end user to conduct scientific assays and titrations effectively in a laboratory setting. Assays or studies of multi component mixtures are advantageously facilitated by the current invention, as the present fluid dispensing device allows one to create a series of mixtures having evenly incremented proportions of constituent ingredients. A volumetric scale may be imprinted or depicted on the said dispenser (100) cartridges (3101) by those skilled in the relevant arts, in order to make the current invention better suited to scientific roles. By using a said cartridge imprinted scale, an end user may obtain an understanding of volumes of fluid used in certain reactions or experiments more easily.

Fluid metering over a wide range of viscocities, from water-thin fluids to heavy gels, is another priority of the current invention. Preferably, from an end user's perspective, ease and precision of ejection of fluids in response to user input should not markedly change with variations in properties of dispensed materials. To this end, each fluid storage and delivery channel (32) in a preferred embodiment of the current invention includes a normally closed check valve (3303) able to admit air into the enclosed internal volume (3302) of a said fluid storage and delivery channel. This said check valve may ensure that suck-back of air into the said internal volume (3302) through a fluid storage and delivery channel's (32) fluid ejection tip (3140) is not required when dispensing highly viscous or gel-like fluids.

The said dispenser (100) offers an advantage in sharing features and certain principles of operation with existing, ubiquitous pipettes. Each said fluid storage and delivery channel (32) includes a bulb like collapsible volume, and ejects fluid due to an increase in internal pressure of, or compression of, the said collapsible volume or bellows (3106). In a similar arrangement to a pipette, an internal fluid reservoir is situated over an ejection port or orifice.

Another important object of the said dispenser (100) is to simplify and to accelerate maintenance and cleaning of the same. Moving parts, friction surfaces, and most passages of said dispenser (100) are not normally wetted by the stored or dispensed materials. In nominal operation, fluids primarily contact or wet the cartridge internal volume (3301) of reusable cartridge (3101). The cartridge entry port (3115) may be tapered, and provides ease of access to cleaning utensils such as pipe cleaners and brushes.

A further aspect of the current invention is ease of access to said cartridge internal volume (3301), and therefore a simplified filling of said cartridges. The said cartridge entry port (3115) taper serves to maximize the entry bore diameter and to provide enhanced access for loading new materials.

Yet another advantage offered by the current invention is the provision of a dual component scale (6000) and tactile control disc (1101) for controlled dispensing of two fluids simultaneously, and a separate single component scale (5000) and tactile control key (1102) for controlled dispensing of a single fluid. Said single component scale (5000) contains a subset of the proportional and volumetric graduations depicted in the dual fluid scale (6000). These said tactile control means (31) allow for multi-channel dispensing to be coordinated over a period of time between different fluid storage and delivery channels.

Due to the described correspondence of the said ratio-metric scales, implementing complex mixtures from a catalog becomes a uniform and streamlined process. The said process may include looking up a color formula in a said catalog, and then tapping or depressing appropriate scale (5000) or (6000) graduations in order to cause appropriate types and volumes of fluids to be dispensed. Re-creating mixtures from one's own working notes, assuming that volumetric or proportional information about past mixtures has been recorded therein, is an equally viable use of dispenser (100).

### SUMMARY OF INVENTION

The present invention relates to a fluid dispensing device (1000) which enables the user to select from a plurality of mixture components prior to dispensing, for production of a wide variety of mixtures having different visual or other properties. The said fluid dispenser (100) disclosed herein includes a plurality of fluid storage and delivery channels (32), a main body (2101), and tactile control means (31), further comprised of a tactile control disc (1101), a set of tactile control keys (1102), and gimballing means for articulating the said tactile controls. Said dispenser (100) resides in a base or work station (4101) when not in use.

A graduated dual component scale (6000) is rendered on said tactile control disc (1101) for selecting and dispensing two mixture components simultaneously at a specified ratio to each other. Said dual component scale (6000) includes at least two series of volumetric graduations, and at least one series of proportional graduations. The said volumetric and proportional graduations may respectively denote individual volumes of, and mutual proportions of, one or two mixture components selected for dispensing.

A graduated single component scale (5000) is rendered on said tactile control key (1102) for selecting and dispensing variable volumes of a single mixture component. Said single component scale (5000) includes a series of volumetric graduations, spanning symbols (5101) through (5103), and proportional graduations, spanning symbols (5201) through (5204). The said volumetric graduations are each representative of a specific volume of fluid. The said proportional graduations may each represent a potential proportion of a currently selected shot volume, to one potentially dispensed at a different time, from a dispenser (100).

An operator may manually depress a specific region, eg. (10), (20), or (60), corresponding to a specific proportion or volume graduation on scales (5000) or (6000), in order to eject a corresponding amount of fluid or fluids from dispenser (100). Each said dual component scale (6000) may be used to interact with one or two corresponding fluid storage and delivery channels (32). Each said fluid storage and delivery channel is associated with, and interacts with, at most one single component scale (5000).

Each said fluid storage and delivery channel (32) is comprised generally of a collapsible volume element or bellows (3106), a detachable fluid reservoir or cartridge (3101), a cartridge fitting or seating means (3102), and check valve (3303).

The said cartridge fitting or seating means (3102) couples the said bellows (3106) to the said cartridge (3101) in a sealing, quick release fashion. Said check valve (3303), said bellows (3106) and said cartridge are mutually in fluid communication via passages (3204) and (3108) of the said cartridge fitting or seating means (3102). Said check valve (3302) is biased to crack when sufficient negative pressure is reached in said fluid storage and delivery channel internal volume (3302), eg. immediately after a quantity of fluid has been ejected and the said bellows re-expands. Thus, said check valve (3303) may maintain fidelity of the response of dispenser (100) to user selected dispensing parameters when repeatedly dispensing substantially viscous materials such as medium to full bodied paint.

The said cartridge (3101) further includes an ergonomic grip means (3112) for tactile interaction of a human operator with the same, and a stepped fluid ejection tip (3140). The said fluid ejection tip (3140) has a first inner diameter (3131), and a progressively smaller second inner diameter (3132). The said fluid ejection tip (3140) may be pared down or trimmed by cutting along the stepped transition (3117) between corresponding outer diameters (3130) and (3113) of the same. This may be useful when performant dispensing of highly viscous materials is desired, as a shorter and wider pared fluid ejection passage (3114) may offer less friction to a dispensed fluid.

The current dispenser (100) is held manually when in use, generally orienting the said fluid ejection tips (3140) towards the ground, and is not intrinsically free standing. To provide functions including upright support of, hydraulic sealing for, and material replenishment of dispenser (100), a work station or base (4101) is taught herein. In order to prevent dry-out or blockage of the dispensing tips (3140) when the dispenser (100) is not in use, a sealing means has been provided. Receptacles or indentations (4208), formed in a projection (4205) from floor (4201) of base cup (400) may seal the cartridges when not in use, and may aid in filling said cartridges when dispenser (100) is selectively aligned with the said sealing means.

A dispenser (100) storage position where the fluid ejection tips (3140) are not sealed may be advantageous when rapid or frequent access to said dispenser is desired. The said sealing indentations (4208) are responsive to the said dispenser's circumferencial orientation (1), (2) relative to a base cup (400) main axis (j), when said dispenser is stored in base (4101). In said circumferencial orientation (1), each cartridge fluid ejection passage (3114) is blocked or sealed. In said circumferencial orientation (2), offset by a 60 degree angle (α) from said circumferencial orientation (1), each cartridge fluid ejection passage (3114) is open to the ambient atmosphere.

The said base may also include an integrated fluid well matrix or deep well palette (410). This said deep well palette may reduce the need to use or transport separate palettes or well matrices. The said deep well palette (410) may be molded from silicone in situ with the said base cup (400), forming a one piece compliant embodiment of said base. The said deep well palette (410) may project from the base main cup (400), and may be reusable and washable due to the well known non-stick properties of silicones.

A streamlined material replenishment solution is contemplated and set forth herein. In summary, an operator may place empty cartridges (c,m,y) into the base cup (400) in a sealing circumferencial orientation (1). An operator may then fill one or more of the said cartridges with a fluid, eg. (k), (w). An operator may then place or urge one or more dispenser (100) cartridge seat cavities (3120) onto one or more cartridge mounting flanges (3105), thereby sealingly completing assembly of fluid channels (32), and finalizing the material replenishment process.

Additional features, advantages, and embodiments of the invention may be set forth or apparent from consideration of the following detailed description. Moreover, it is to be understood that both the foregoing summary of the invention and the following detailed description are exemplary and intended to provide further explanation without limiting the scope of the invention.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a general three quarters view of said fluid dispensing device (1000);

FIG. 2 is a cutaway view of said dispenser (100);

FIG. 3 shows a mid-cycle view of said dispenser (100) during simultaneous fluid dispensing;

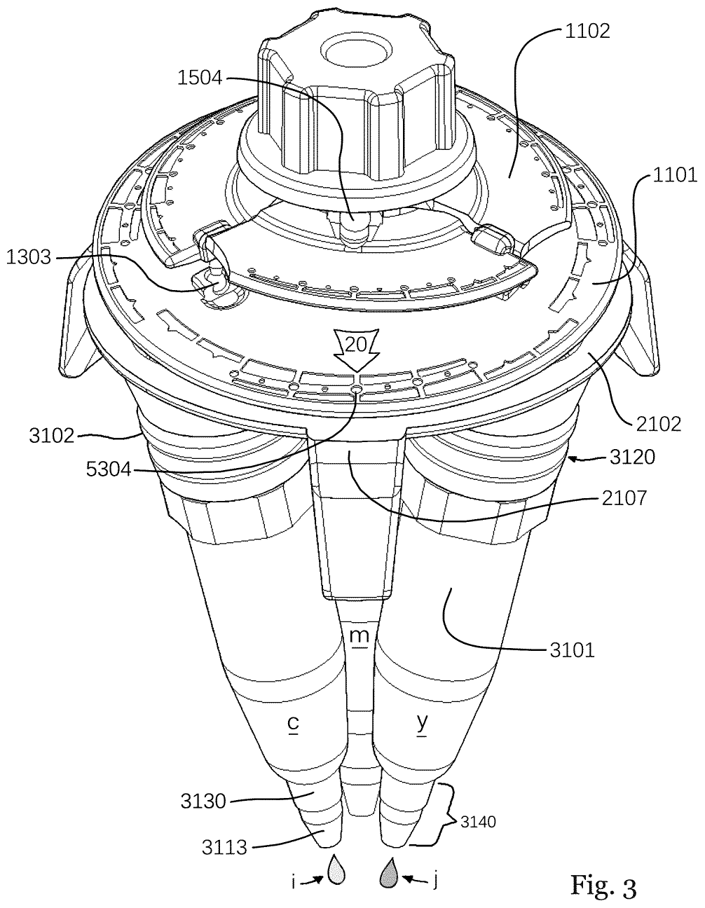

FIG. 4 is a top view of said dispenser (100) showing said scales (5000) and (6000);

FIG. 5 is an exploded view of said dispenser (100);

FIG. 6 details operation of said tactile control key (1102);

FIG. 7 is a general three quarters view of said stand or base (1401);

FIG. 8 is a perspective views of cartridge fitting or seating means (3102) and cartridge (3101);

FIG. 9 illustrates a filling sequence, where said dispenser (100) is provisioned with fluids (k), (w);

FIG. 10 details said cartridge (3101) sealing configurations in base (1401);

FIG. 11 presents an alternate view of tactile control key (1102) and supporting elements.

### DETAILED DESCRIPTION OF THE EMBODIMENTS

With reference to the drawings, a said fluid dispensing device (1000) is shown in accordance with an example embodiment and includes a number of components and assemblies that together provide various operational modes for selecting and dispensing a pair of liquids proportionally and dispensing a single liquid individually. Said fluid dispenser (100) disclosed herein includes a said main body (2101) adapted to mount a plurality of said fluid storage and delivery channels (32) symmetrically around a main axis (1300), and adapted to mount tactile control means (31) for closely interacting with said fluid storage and delivery channels (32). A work station or base (4101), having features for storing, sealing, and filling said dispenser (100) is also disclosed herein.

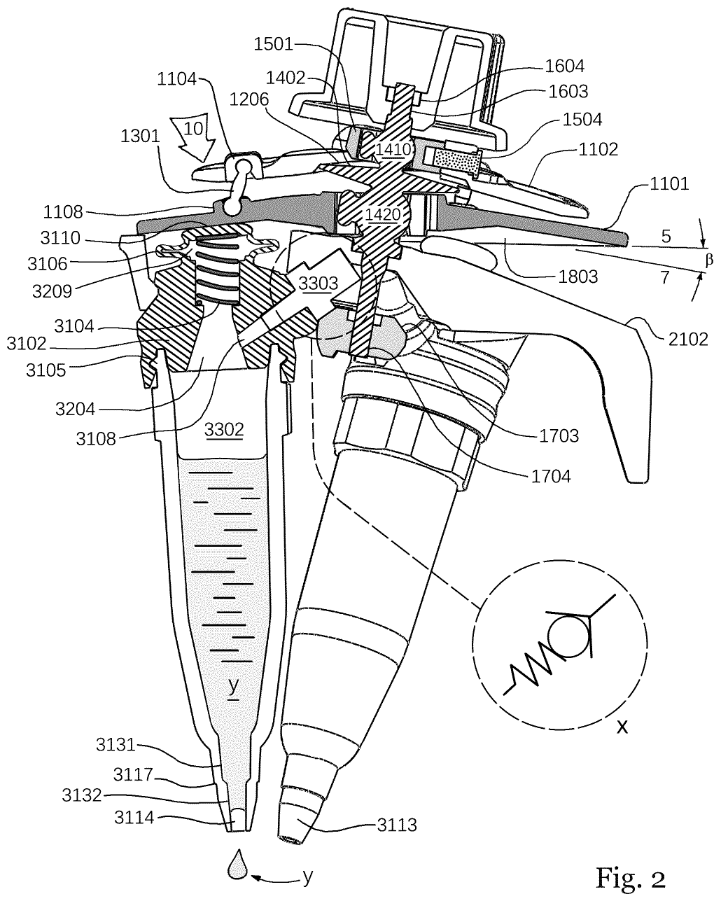

Referring to FIGS. 2, 5 and 6, a gimballing assembly including a mast (1401) and a ring element (1501) is mounted in central bore (2105) of the said main body (2101) via said mast's (1401) first threaded post (1405). Said mast (1401) is keyed to said central bore (2105) and prevented from rotating therein by a hexagonal flange (1404). Said flange (1404) is accepted by a reciprocal, hexagonal countersunk recess (2108) in said main body. A threaded bore (1704) of hemispherical grip (1701) engages said first threaded post (1405) as it exits said central bore (2105). Said hemispherical grip (1701) fastens the check valves via conical surface (1703), applying opposed retaining torques to said mast (1401) and said check valves (3303), thereby fastening the above said elements on main body (2101).

Ridged handle (1601) mounts onto a second threaded post (1407) of said mast (1401) via internal bore (1603). It is secured on said second threaded post (1407) by hex nut (1602), retained in a countersunk hexagonal recess (1604) of said ridged handle (1601). Said ridged handle (1601) may simplify an operator's handling of dispenser (100), specifically when lifting said dispenser (100) from work station or base (4101), or emplacing said dispenser (100) onto said base. For gripping and manipulating said dispenser (100) during operation thereof, a set of equi-spaced handles (2112) are positioned around main body (2101) periphery (2102).

The said tactile control disc (1101) mounts to said mast (1401) via a first constant velocity (CV) joint which facilitates nutation. The said CV joint includes a spherical bearing (1420) and ball ended projections (1403) disposed on the said bearing. The tactile control disc includes a substantially central spherical journal surface (1220), which accepts the said spherical bearing (1420), and a set of prismatic grooves (1203), which accept the said CV joint ball ended projections (1403).

In a preferred embodiment of dispenser (100), said tactile control disc (1101) nutates about a central point defined by said CV joint, thereby acting on at least one said fluid delivery channel (32) cam following surface (3110) at all feasible angular inclinations, unless the said tactile control disc is in a resting position. Tactile control disc (1101) is capable of actuating two fluid channels simultaneously when depressed manually at its periphery, eg. as indicated by arrow (20), substantially between cam following surfaces (3110) of two said fluid delivery channels (32).

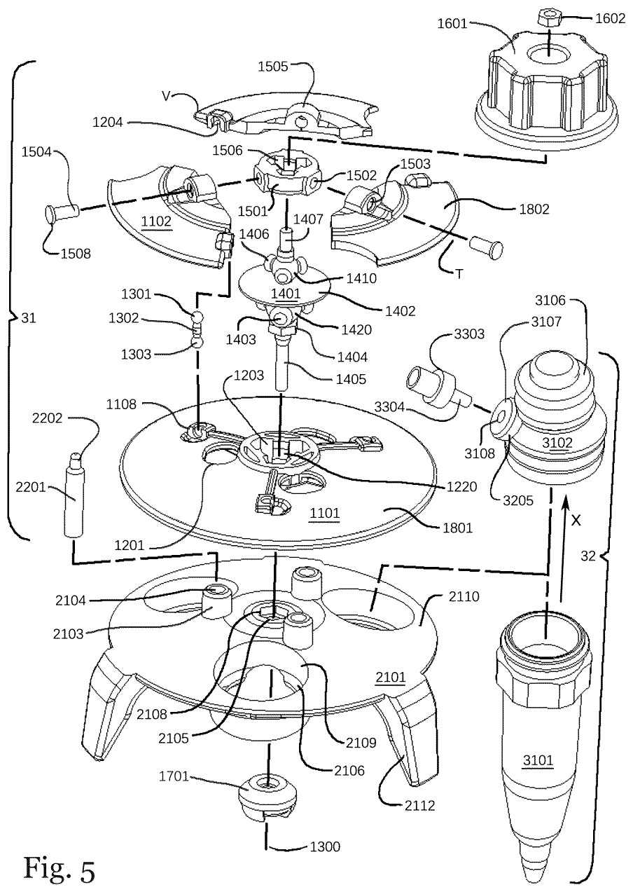

As detailed in FIGS. 5, 6, and 11, said ring element (1501) mounts to said mast (1401) via a second constant velocity (CV) joint which facilitates nutation. The said second CV joint includes a spherical bearing (1410) and ball ended projections (1406) disposed on the said bearing. Said ring element (1501) includes a substantially central spherical journal surface (1520), which accepts the said spherical bearing (1410), and further includes a set of prismatic grooves (1506) which accept the said second CV joint ball ended projections (1406).

The said first and second CV joints inhibit rotation of said tactile control disc (1101) and said tactile control key (1102) relative to said main body (2101) and mast (1401). The said ball ended projections (1403) and (1406) each terminate with a sphere, and are identical in function with those found in widely known ‘tripod’ CV joints. As in conventional tripod CV joints, said prismatic grooves (1203) and (1506) each have cross sections which exhibit a slight taper, gapping wider towards said respective spherical journal surfaces (1220) and (1520). Each said prismatic groove (1203), (1506) constrains each said corresponding ball ended projection (1403), (1406), to traversing their length in an arcuate motion, as said spherical journal surfaces (1220), (1520) nutate about respective said spherical bearings (1420), (1410).

Three pins (1504) project from bores (1502) in an annular surface of the said ring element (1501) at equal intervals. The said pins' revolute axes are substantially coplanar. Each said pin passes through a bore (1503) of a said tactile control key (1102), and serves as a rotary tilt axis (T) for each said tactile control key. Projection (1505) houses and supports said bore (1503). Each said pin (1504) includes a retaining means such as a flange or head (1508), wherein the said retaining means substantially eliminates linear movement of the said tactile control key (1102) along said axis (T).

Each said tactile control key (1102) is kinematically linked to the said tactile control disc (1101) via a barbell like linkage rod (1302). The said linkage rod first ball end (1301) mates to a spherical socket (1204), integral to projection (1104), disposed by a vertex (V) of said control key. The said spherical socket (1204) is disposed substantially above and over a cam following surface (3110) of a fluid storage and delivery channel (32), and is distal to the said control key pin bore (1503). The said linkage rod second ball end (1303) is accepted by spherical socket (1205), disposed on an outer surface (1801) of tactile control disc (1101), preferably substantially above and over the same said fluid storage and delivery channel (32) cam following surface (3110).

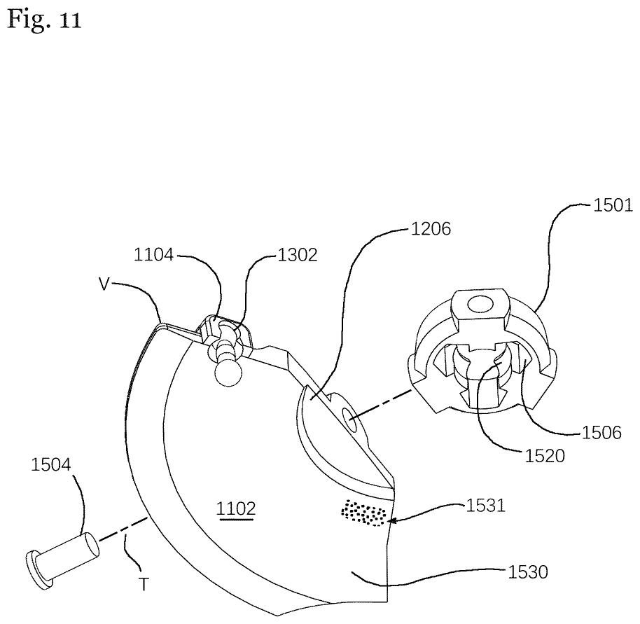

Turning to FIGS. 5, 6, and 11, said axis (T) substantially bisects tactile control key (1102), as depicted in FIGS. 5 and 11. A cam follower finger (2202), extending from a spring loaded cam follower means (2201) resident in said main body (2101), and protruding through port (1201) of said tactile control disc (1101), slidably contacts an inner conical surface (1530) of tactile control key (1102), in a contact region (1531). The said contact region (1531) is disposed opposite to spherical socket (1204) with respect to said axis (T).

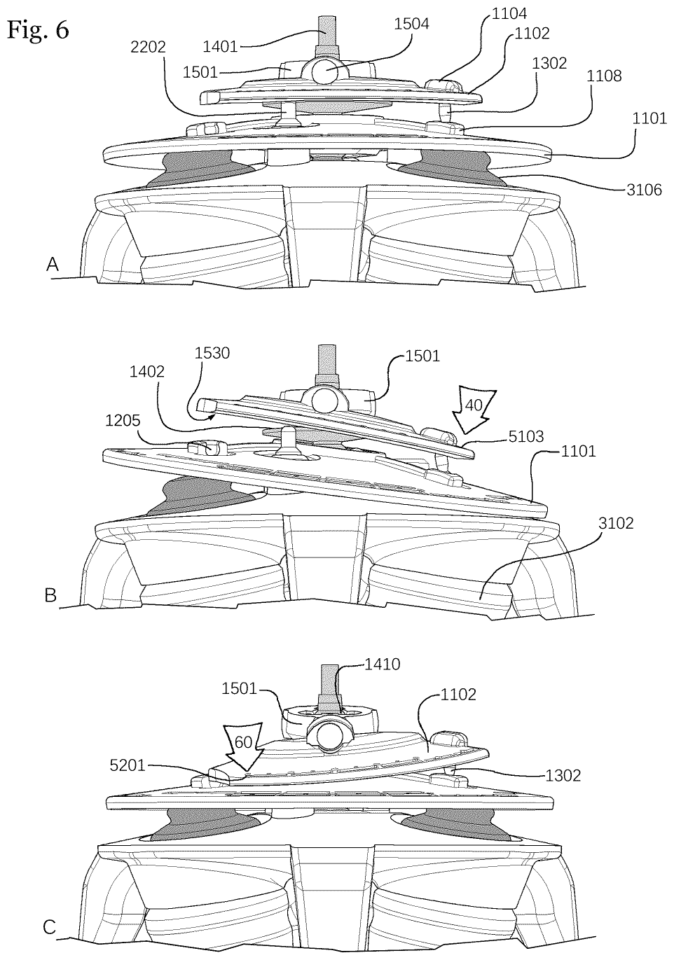

Thereby, as depicted in FIG. 6, Exhibit C, when said tactile control key (1102) is depressed at a single component scale (5000) origin graduation (5201), or in the vicinity and direction of arrow (60), pressure or a torque is transmitted primarily to the said cam follower means (2201). The said tactile control key (1102) nutates about spherical bearing (1410) together with said ring element (1501), also tilting counter-clockwise about axis (T) as depicted herein. Due to the imparted torque, and said linkage rod, and tactile control disc (1101) are unable to transmit sufficient torque to a spring (3104) and said bellows (3106), in order to collapse the said bellows element. In effect, elements comprising axis (T) present a mobile fulcrum, wherein any tactile control key (1102) displacement from rest results in said fulcrum's nutation about spherical bearing (1410).

Conversely, as depicted in FIG. 6, Exhibit B, when tactile control key (1102) is depressed at the single component scale (5000) maximum volumetric graduation (5103), or in the vicinity and direction of arrow (40), pressure or a torque is transmitted primarily to the said linkage rod (1302). The said tactile control key (1102) nutates about spherical bearing (1410) together with said ring element (1501), also tilting also tilting clockwise about axis (T) as depicted herein. The said linkage rod (1302) transmits torque to said tactile control disc (1101), which tilts and collapses the said bellows (3106) and said internal spring (3104), causing an ejection of a metered shot of fluid.

Turning to FIGS. 2, 5, and 11, we find depicted the means that define or limit motion of said tactile control key (1102). A said tactile control key (1102) may nutate substantially independently of tactile control disc (1101) in some scenarios, for example when an operator has depressed said tactile control key (1102) at the single component scale (5000) origin graduation (5201). To prevent collision between said tactile control key (1102) and tactile control disc (1101), a limiting disc-like flange (1402) for constraining nutation of said tactile control key (1102) about spherical bearing (1410) is depicted in FIGS. 2, 5 and 6. A recessed conical surface (1206) of said tactile control key (1102), located in close proximity to said disc-like flange (1402), may contact said disc-like flange at a pre-determined limit of its angular displacement.

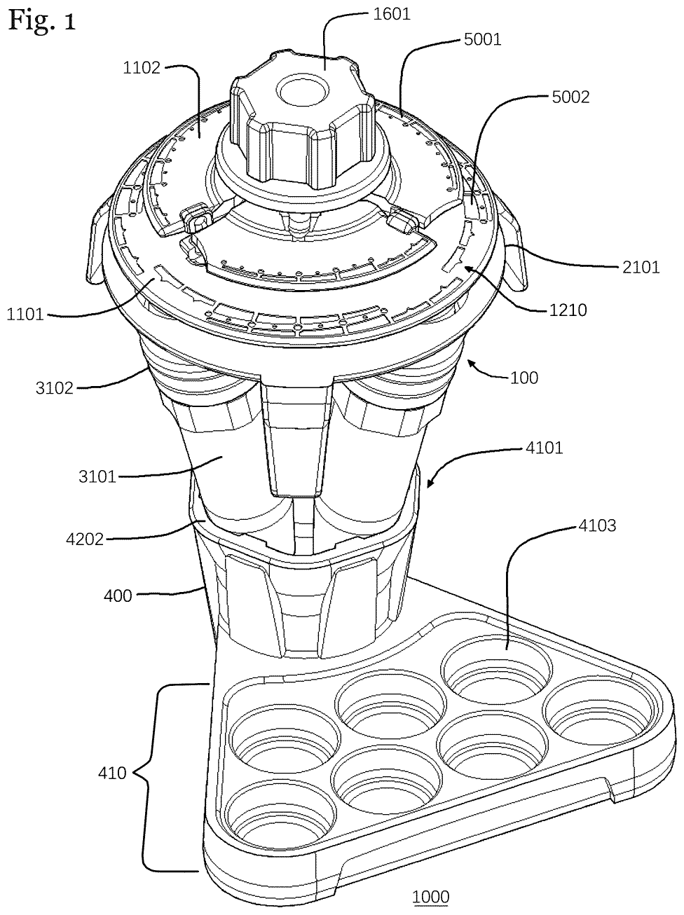

Turning to FIGS. 1, 2, and 5, we find a said fluid storage and delivery channel (32) which comprises of said cartridge (3101), said cartridge fitting or seating means (3102), said internal compression spring (3104), said collapsible volume means or bellows (3106), said cam following surface (3110), and said check valve (3303). Check valve stem (3304) sealingly resides in passage (3108), passing through valve seat face (3107). Said valve seat face (3107) is disposed on projection (3205), emanating from said cartridge fitting or seating means (3102). Preferably, three of the said fluid storage and delivery channels (32) are arranged symmetrically about main body axis (1300), near the periphery (1210) of the tactile control disc (1101) at equal intervals. Preferably, said cam following surface (3110) is at rest disposed at a substantially tangential orientation to said tactile control disc's contact surface (1803), in order to maintain positive contact with disc (1101) throughout a dispense cycle.

Bellows internal volume (3209), air passages (3204) and (3108), and cartridge internal volume (3301) define a fluid storage and delivery channel internal volume (3302), which may be reduced when cam following surface (3110) is displaced from an at-rest positon, in turn collapsing the said normally expanded bellows (3106) via said actuation and selection means (1101). Said spring (3104) disposed within the said bellows (3106) accelerates and assures re-expansion of said bellows at the end of each dispense cycle. At rest or when expanded, said spring also prevents any undesirable collapse of the said bellows due to the weight of the stored fluid (y) and the negative pressure which this said fluid may exert on said internal volume (3302).

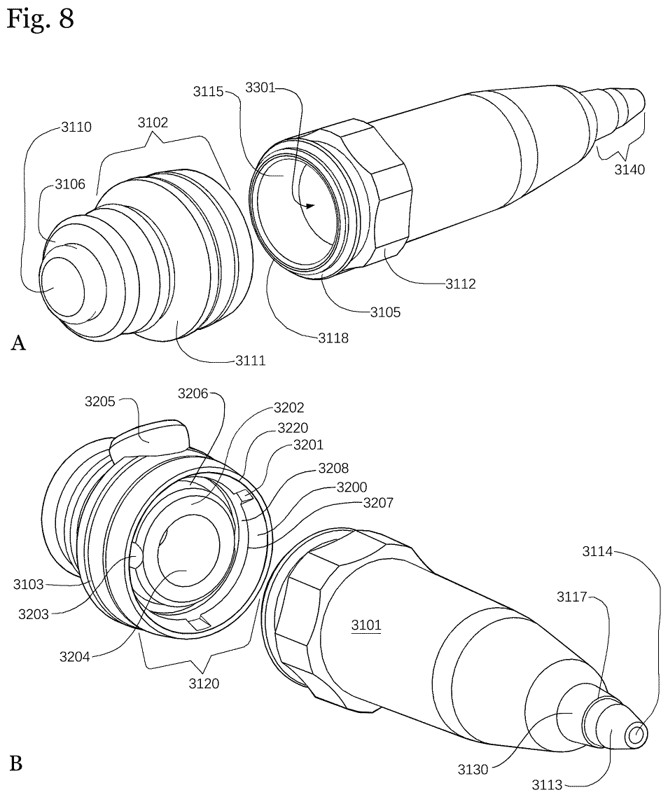

FIG. 8 depicts the said cartridge fitting or seating means (3102) and cartridge (3101) in detail, and illustrates the principal elements responsible for sealingly coupling the said fitting or seating means (3102) to said cartridge (3101). Preferably, the said cartridge fitting or seating means (3102) is manufactured as a compliant element molded in situ with said bellows (3106). During installation or assembly of a said cartridge (3101) into said cartridge fitting or seating means (3102), the cartridge fitting or seating means cavity (3120) inner periphery (3207) and seal land (3200) expand in order to accept cartridge (3101), and to seat cartridge (3101) male mounting flange (3105) in inner groove (3208), adapted to receive said mounting flange (3105).

Turning to FIGS. 5 and 6, we may observe the means by which said cartridge fitting or seating means (3102) mounts to said main body (2101). Male flange (2106) on said main body (2101) is accepted by and resides in an annular female indentation (3103) on said cartridge fitting or seating means (3102). Openings (2109) include the said flange (2106) and provide clearance for mounting and operation of said cartridge fitting or seating means (3102) in said main body (2101).

Returning to FIG. 8, projection (3206) may center said cartridge fitting or seating means cavity (3120) on cartridge entry port (3118) during assembly. Substantially tapered passage (3204) originates on face (3202) of said projection (3206) and provides fluid communication to the said bellows interior volume (3209) of the said collapsible volume means (3106). This said passage (3204) presents a substantially wide, tapered opening on said face (3202), facilitating enhanced access for cleaning tools such as a spray nozzle to said bellows interior volume (3209) for chemical decontamination and sanitization.

Undesirable drips from a fluid ejection tip (3140) of the taught dispenser (100) may occur during or immediately after coupling of a said cartridge (3101) to the said cartridge seating means (3102). Such losses of fluid may be caused by pressure changes which have occurred within said cartridge internal volume (3301) in the course of said coupling. To create a pressure relieving conduit, a groove or channel (3201) is provided in the seal land (3200) between the entry port (3220) of said fitting element and said inner groove (3208).

To further reduce pressure buildup during fitting or installation of a said cartridge (3101), projection (3206) includes a substantially co-axial annular channel (3203). As said projection (3206) is plunged into an open end of a cartridge during installation, air is allowed to escape from said cartridge internal volume (3301) via said annular channel (3203), thereby preventing projection (3206) from temporarily acting as a piston.

FIG. 8 also depicts an ergonomic grip means (3112) for holding or manipulating said cartridge (3101). Those skilled in the relevant arts may implement this grip as a substantially wide and thin flange, like that which may be found on a conventional syringe barrel, or as a thick, scalloped grip (3112) depicted herein.

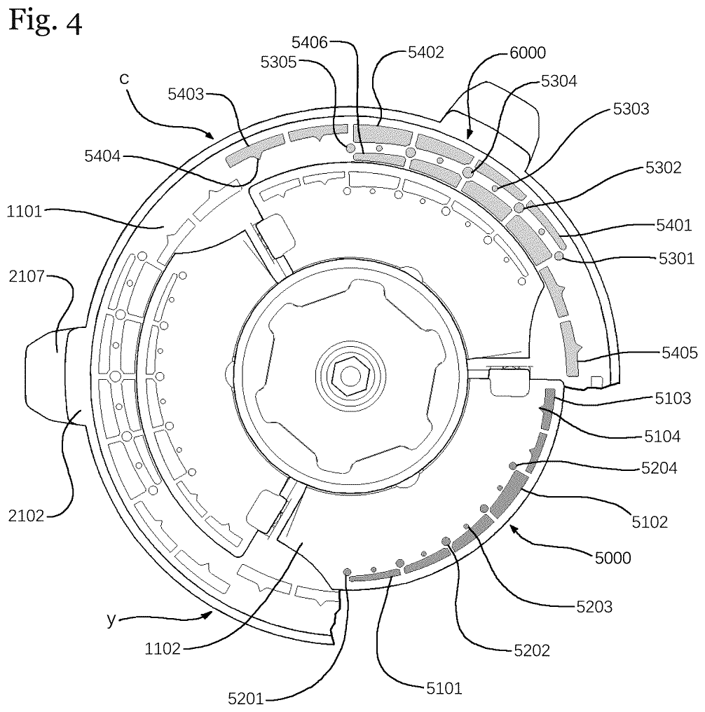

Turning to FIG. 4, rendered on tactile control disc (1101) is a dual component scale (6000) for selecting and dispensing one or two fluids simultaneously at a specific mutual ratio or at a specific volume, and a single component scale (5000) for dispensing a fluid at a specific volume or at a specific implied ratio. Two distinct series of volumetric graduations, spanning graduations (5301) through (5305), and spanning graduations (5405) through (5406), respectively, are included in a said dual component scale (6000). A volumetric graduation series is thus provided for each of the two different fluids which may be ejected in the course of using said scale (6000).

Said scale (6000) further includes a series of graduations denoting certain proportions of a first to a second mixture component, which may both be dispensed simultaneously. Proportion graduations (5301), (5304), (5303), and (5305) may respectively correspond to ratios 1:20, 1:1, 1.66:1, and 20:1, of a first dispensed fluid to a second dispensed fluid. Certain regions or graduations, eg. (5103) and (5403) of dual component scale (6000) denote exclusively volumetric, single channel dispensing of a specific fluid component.

Said exclusively volumetric graduations, eg. (5103) and (5403) are not rendered between two said proportion graduations. These standalone graduations, eg. (5103) and (5403), represent shot volumes at which, due to geometric constraints imposed in the interaction of said tactile control disc (1101) and said fluid channel cam following surfaces (3110), no multi-channel simultaneous fluid dispensing may occur from said dispenser (100). These said standalone shot volume graduations (5103) and (5403) may further include notched elements (5104) and (5404) which may subdivide the said graduations (5103) and (5403) into yet finer increments.

Both said scales (5000) and (6000) include at least one series of linear volumetric graduations, eg. (5101) through (5103). Each of the said volumetric graduations may be equivalent to 0.14 ml, or four 0.035 ml drops of fluid. Preferably, the said graduations are each rendered relatively smaller where a lower shot volume is denoted, eg. element (5101), and are rendered relatively larger where a higher shot volume is denoted, eg. element (5102).

One series of volumetric graduations, spanning graduations (5101) through (5103), is included in a said single component scale (5000) for metering out specific volumes of a fluid. Said single component scale (5000) also includes a series of linear proportion graduations, including elements (5201), (5202), (5203), and (5204). The said proportion graduations may respectively correspond to ratios 1:20, 1:1, 1.66:1, and 20:1 of a currently dispensed fluid to a potential other fluid which may be dispensed from a same or other fluid storage and delivery channel (32) at a different point in time.

Referring to FIG. 2, said tactile control disc (1101), said bellows (3106) and said spring (3104) are shown in a working configuration that may occur when a quantity of a selected fluid has been ejected. A hydraulic diagram (X) of said check valve (3303), clarifying its basic function and orientation, may also be found in FIG. 2. Preferably, the said check valve (3303) is spring biased, bubble tight, and has a minimal feasible cracking pressure, with respect to the above requirements.

To initiate a dispense cycle, thereby initiating dispensing of a stored fluid (y), cam following surface (3110) is urged towards a said cartridge fitting or seating means (3102) by said tactile control disc (1101), when an operator has manually depressed said tactile control disc (1101) in the vicinity and direction of arrow (10), as shown in FIG. 2. In this illustration, said tactile control disc (1101) has performed an angular inclination spanning angle (P), moving from an initial resting position (7), substantially parallel to main body periphery (2102), to a fully tilted position (5).

The tilting motion or stroke of tactile control disc (1101) about spherical bearing (1420) is limited by the external, conical surface (2110) of body shell (2101). During such a stroke of said disc, air pressure increases in constrained internal volume (3302), causing the said stored fluid (y) to be ejected from said cartridge (3101).

Upon a return of the said tactile control disc (1101) and said bellows (3106) to corresponding initial states, air may be aspirated into said cartridge internal volume (3301) via fluid ejection passage (3114), in order to replace the ejected fluid (y), unless said fluid's viscosity is substantially high. If a dispensed fluid (y) has sufficient viscocity to prevent the described air aspiration, check valve (3303) may crack open in order to admit a volume of air into said internal volume (3302), thereby restoring pressure balance with the ambient atmosphere. Once the said ejected fluid is replaced with air, a dispense cycle is understood to be complete.

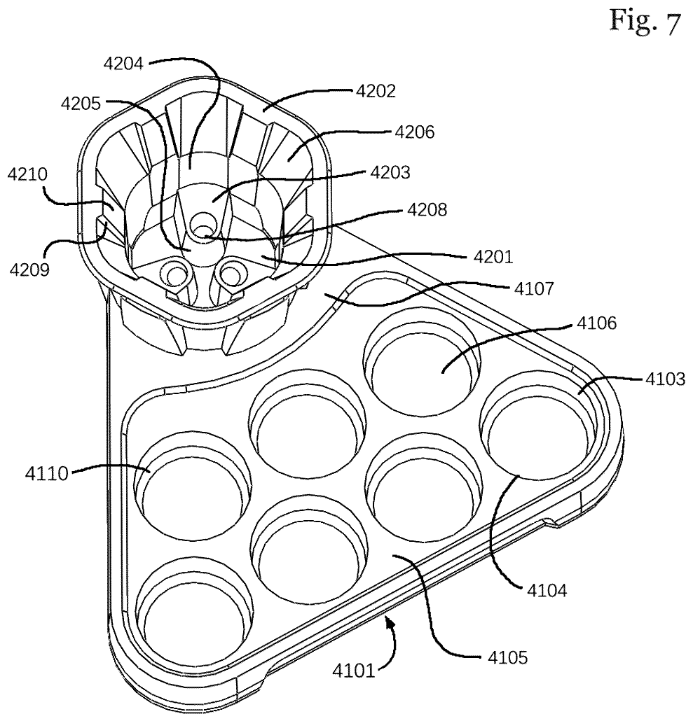

Turning to FIGS. 1 and 7, illustrated therein is a work station or base (4101). This said base or work station includes a faceted hexagonal cup (400) having smooth fillets or transitions (4206) between each cup face. The said cup faces are each bisected with a rib (4210). Together, a said transition (4206) and a pair of said vertical ribs (4210) may conformantly support and maintain a cartridge (3101) in a substantially vertical orientation. Said cup (400) may also provide stable support for a fully assembled dispenser (100). The said ribs serve to support a cartridge during material loading, and to enhance stability of the said dispenser (100) when a fully assembled dispenser (100) is placed in a said cup (400).

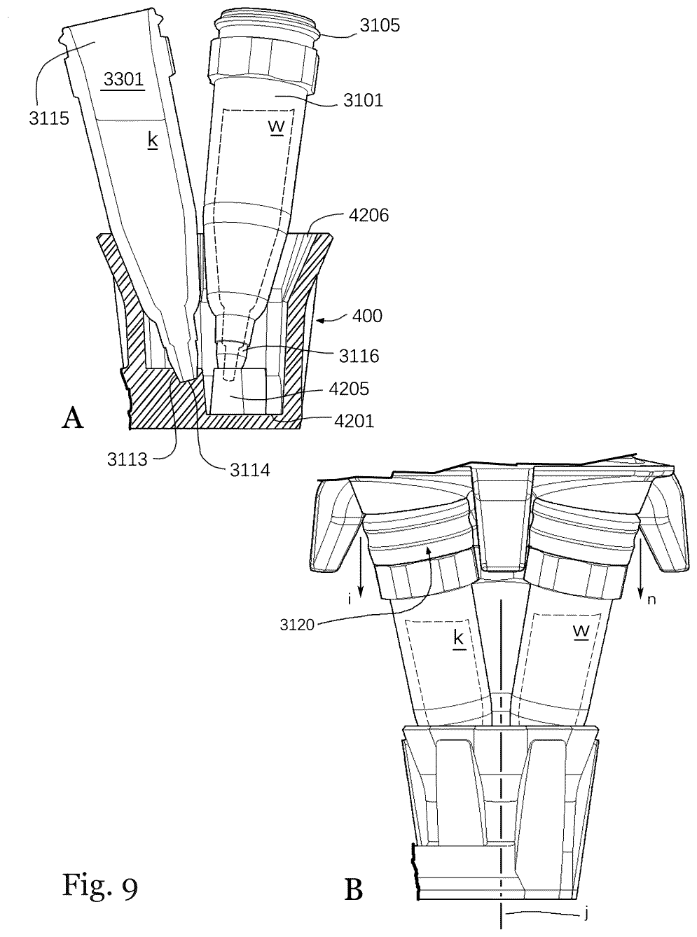

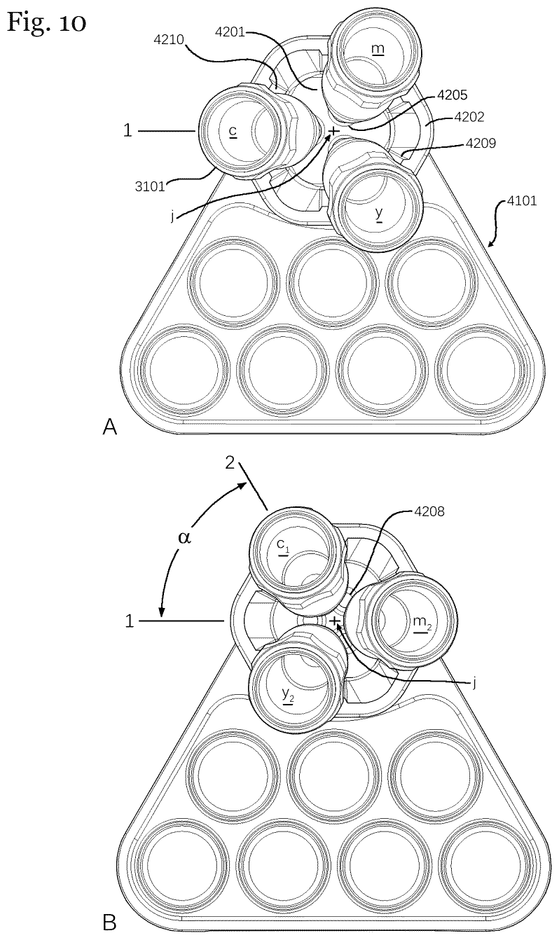

In FIGS. 9 and 10, a first orientation (1) of a set of cartridges in base (4101) is illustrated, wherein each cartridge fluid ejection passage (3114) is blocked or sealed. Situated on the floor (4201) of the said cup are projections (4205) having receptacles or indentations (4208) therein. Each cartridge's fluid ejection tip (3140) is inserted into a corresponding said receptacle or indentation (4208), and is supported conformantly by said cup walls (4202) and said support ribs (4210).

The said projections (4205) and said hexagonal cup's six cartridge positions facilitate a second orientation (2) of a set of cartridges, wherein an assembled dispenser (100) may be placed into said cup (400) without sealing of the said fluid ejection tips (3140). In this second said orientation (2), a set of cartridges (3101) is offset by angle (α) from the position of a set of cartridges in orientation (1), and each cartridge fluid ejection tip (3140) rests between the said projections (4205).

A well palette (410) projecting from the said base cup (400) is depicted in FIGS. 1, 7, and 10. This said palette preferably contains a multitude of fluid wells (4104) wherein the volume of each well

The invention claimed is:

1. A dispenser for delivering one or more fluids, comprising:
a main body adapted for mounting one or more fluid storage and delivery channels and an arrangement of volumetric selection and actuation means thereon;
a first selection and actuation means for controlling release of a fluid from a said fluid storage and delivery channel, the said means include a tactile control key that may cause ejection of a specific and selectable volume of a fluid when depressed;
a second selection and actuation means for controlling release of one or two fluids from one or two said fluid storage and delivery channels, the said means include a nutatable tactile control disc which may cause ejection of a specific and selectable volume of one or two fluids when depressed;
a gimballing assembly mounted onto the said main body, the said assembly includes means for bearing and articulation of the said tactile control key and said tactile control disc thereon;
and at least one fluid storage and delivery channel, which includes means for fluid storage and ejection.

2. A fluid storage and delivery channel of claim 1, further comprising:
a normally expanded collapsible volume means or bellows in fluid communication with said cartridge of claim 1, and a cam following surface for controlling the state of the said collapsible volume means, wherein fluid ejection from said fluid storage and delivery channel may be caused by displacing the said cam following surface;
a cartridge consisting of a hollow, tubular main body, open at a first end, and closed on a second end, a fluid ejection tip which includes a fluid ejection passage and is disposed on a said second end of the said main body, and a mounting flange disposed on the said first end of said main body, wherein the said cartridge acts as the principal fluid reservoir of current fluid storage and delivery channel, and the said main body open end provides an access port for materials and cleaning tools;
a cartridge fitting or seating means projecting from said collapsible volume means, for installation of said cartridge thereupon, wherein the said mounting flange may sealingly mate to said cartridge fitting or seating means.

3. A cartridge fitting or seating means of claim 2, projecting from said collapsible volume means of claim 2, and in fluid communication with said cartridge and said collapsible volume means of claim 2, comprising:
a female sealing region or cavity disposed on an end face of said cartridge fitting or seating means, the said female sealing region having an inner groove adapted to receive a corresponding male mounting flange, and having at least one groove or channel formed in the seal land between the entry port of said fitting element and said inner groove, whereby the said channel may provide fluid communication between said inner female groove and ambient atmosphere during coupling of said groove to said mounting flange;
and a male sealing region on said cartridge, having an annular mounting flange disposed thereon, substantially near said cartridge open end, the said mounting flange is tapered in cross section, progressing outwards from cartridge body to a substantially rounded or filleted annulus, from a comparatively wide root region.

4. A fluid ejection tip of claim 2, which includes a first section having a first inner diameter, and a second section having a second inner diameter, smaller in relation to that of the first section's, whereby the end user may remove the second said fluid ejection tip section in order to increase the orifice diameter through which fluid is ejected from said cartridge, and in order to decrease the total fluid ejection passage length, thus reducing the friction encountered by highly viscous materials in exiting the said cartridge.

5. A fluid ejection tip of claim 2, which includes a first section having a first outer diameter, and a second section having a second outer diameter, smaller in relation to the first section, thereby allowing the end user to cut along, and align cutting tool with, a physically tangible guide edge.

6. A fluid storage and delivery channel of claim 1, further comprising a normally closed check valve adapted to check air flow from the internal volume of said fluid storage and delivery channel to ambient atmosphere, and to admit air into the said internal volume in response to negative pressure within the said internal volume.

7. A fluid storage and delivery channel of claim 1, further comprising a compression spring biased to expand the said collapsible volume claimed in claim 1, disposed within the said collapsible volume.

8. A cartridge of claim 1 further comprising an ergonomic grip means such as a flange or projection, disposed near an entry port of said cartridge.

9. An input key selection and actuation means of claim 1, comprising:
a tactile input key element mounted via a rotary joint to an intermediate ring element, whereby said key may be depressed or operated to attain at least one attitude or position at which no fluid is released, and which may also be operated to attain another attitude or position at which a maximum fluid shot is released, and may also attain a plurality of intermediate operational attitudes or positions therebetween, where each said position is part of a progression of fluid shot volumes, from a minimum to a maximum attainable fluid shot size;
a linkage rod, coupled via a first spherical joint to a first vertex of the said input key, and coupled via a second spherical joint to a point located on the said selection and actuation disc of claim 1, substantially near a said integral actuator means;
and a normally extended cam follower means installed onto said main body of claim one, whose follower finger is in sliding contact with the said input key substantially near a second vertex thereof, whereby the said cam follower means and the said linkage rod flank the said rotary joint on different and opposing sides.

10. A tactile control key of claim 1, further comprising a single component scale, depicted thereon, the said scale denoting a series of dispensed fluid shot volume graduations, as well as a series of proportion graduations, having at least upper, lower and median fluid ratio markings.

11. A tactile control disc of claim 1, further comprising a dual component scale, depicted thereon, the said scale denoting a range of mutual proportions of two dispensed fluids, having at least upper, lower and median ratio graduations, as well as two distinct and substantially overlapping series of dispensed fluid shot volume graduations.

12. A gimbaling assembly of claim 1, comprising:
a mast which includes a first spherical bearing which facilitates nutation of the said tactile control disc of claim 1, the said bearing further comprising an anti-rotation means,
and a second spherical bearing which provides for nutation of an intermediate ring element, the said second spherical bearing further comprising an anti-rotation means;
a said ring element which includes a set of journal surfaces for mating with and nutating about the said mast, and at least one pin projecting from an annular surface thereof, whereby the said pin provides a bearing surface and an axis of rotation for said control key of claim 1;
and a said tactile control disc which includes a set of journal surfaces for mating with and nutating about the said mast;
wherein said bearing pairs function as constant velocity joints, and the said anti-rotation means may be implemented as a pin and groove pair on corresponding elements of a said bearing.

13. A base or work station for accepting and securing dispenser of claim 1, comprising:
a cup, having walls which conform substantially to the said cartridges of said dispenser, and is of sufficient height and thickness to support the total mass of a complete and assembled dispenser of claim 1.

14. A base or work station of claim 13 which includes a set of substantially vertical rib-like projections formed on inner walls of said cup, able to align with and to retain one or more cartridges of fluid dispensing device of claim 1 in a substantially vertical orientation.

15. A base or work station of claim 13 which further comprises at least one receptacle or indentation therein, cross sectioned generally conformantly to a cartridge fluid ejection tip of fluid dispensing device of claim 1, thereby blocking fluid ejection passage of said fluid ejection tip upon insertion or partial insertion of said fluid ejection tip therein.

16. A base of claim 8 which includes a well palette which adjoins or projects from the said cup, and has at least one fluid well.

17. A method of installation of cartridges onto a cartridge fitting or seating means of claim 3, including a replenishment of the dispensed material for the said dispenser, comprising the steps of:
placing a one or more said cartridge (c,m,y) into a base cup, so that a cartridge fluid ejection tip sealingly contacts a receptacle or indentation of said base cup, whereby a circumferencial orientation of a set of cartridges may be attained, in which each cartridge fluid ejection tip is capped by the said indentations;
filling a one or more of the said cartridges (c,m,y) by pouring or introducing desired fluid material(s) through each said cartridge entry port;
axially aligning each fitting or seating means cavity of the said dispenser with each of the said cartridges' mounting flanges, to the extent possible;
and urging a each cartridge fitting or seating means of the said dispenser onto each said cartridge mounting flange until all of the said cartridge seating means are sealingly assembled to each said cartridge.
